(19) United States
(12) Patent Application Publication
(10) Pub. No.: US 2020/0295970 A1
(43) Pub. Date: Sep. 17, 2020

(54) METHOD AND SYSTEM FOR AUTOMATIC SELECTION OF VIRTUAL NETWORK FUNCTIONS (VNF) IN A COMMUNICATION NETWORK

(71) Applicant: Nokia Solutions and Networks Oy, Espoo (FI)

(72) Inventors: Vijay Gurbani, Lisle, IL (US); David Faucher, Guthrie Center, IA (US); Edward Grinshpun, Freehold, NJ (US); Sameerkumar Sharma, Holmdel, NJ (US)

(21) Appl. No.: 16/758,008

(22) PCT Filed: Oct. 23, 2017
(86) PCT No.: PCT/US17/57852

§ 371 Date: Apr. 21, 2020

(51) Int. Cl. H04L 12/46; H04W 24/02; G06N 20/00; G06N 5/04

(52) U.S. Cl. CPC H04L 12/4641; G06N 5/04; G06N 20/00; H04W 24/02

(57) ABSTRACT

The method includes obtaining a first set of support and confidence parameters, identifying a first set of VNFs of a plurality of VNFs of the communication network based on the first set of support and confidence parameters, and determining association information by mining rules within VNFs of the first set of VNFs using the support and confidence parameters. A second set of VNFs, of the plurality of VNFs, are then selected based on the association information, and an operation of the communication network is controlled using the first set of VNFs and the second set of VNFs.

### BACKGROUND

### Field

Example embodiments relate generally to a method and a system for the automatic selection of virtual network functions (VNF) in a communication network

### Related Art

Communication networks can offer a number of abstractions to support new service demands from a variety of users, machines, industries, governments and other organizations. In a 5^{th} generation wireless communication network (5G network), the network architecture is based on concepts of network function virtualization, software defined networking, and cloud computing. The 5G architecture allows native support for classes of services on a common physical network infrastructure. For example, a same 5G network radio access and cloud computing equipment may be capable of providing ultra-low latency services, that may for instance be used with remote robotic surgeries, remotely controlled vehicles, analytics driven assembly lines, while the 5G network may also serve bandwidth hungry applications that may be used for high-energy physics, ultra-high definition virtual-reality streaming, etc. Meanwhile, the network may also interface with a large number of connected devices (such as Internet of Things devices, referred to herein as ‘IoT devices’), where these IoT devices may have a diverse set of service requirements. These diverse service requirements may include, for instance, a refrigerator that may be an IoT device that may only interact with the network sporadically, in comparison to a moving vehicle that may require short bursts of data transmission and/or sensor data that may require a constant flow of small packet traffic in the network. Recruiting network services to handle these diverse network needs can be challenging.

### SUMMARY

At least one example embodiment relates to a method of selecting virtual network functions (VNFs) to control an operation of a communication network.

In one embodiment, the method includes obtaining, by at least one first processor, a first set of support and confidence parameters; identifying, by the at least one first processor, a first set of VNFs of a plurality of VNFs of the communication network based on the first set of support and confidence parameters; determining, by the at least one first processor, association information by mining rules within VNFs of the first set of VNFs using the support and confidence parameters; selecting, by the at least one first processor, a second set of VNFs of the plurality of VNFs based on the association information; and controlling, by the at least one first processor, an operation of the communication network using the first set of VNFs and the second set of VNFs.

In one embodiment, the selecting of the second set of VNFs accomplishes this selection without choosing any VNFs, of the plurality of VNFs, that belong to the first set of VNFs.

In one embodiment, the identifying of the first set of VNFs includes, filtering a plurality of data mining rules for the communication network, using the first set of support and confidence parameters, to derive a first set of data mining rules, data mining the plurality of VNFs to identify the first set of VNFs using the first set of data mining rules.

In one embodiment, the obtaining of the first set of support and confidence parameters includes, obtaining support parameters that represent a frequency of inference information within previous slice instance datasets, and obtaining confidence parameters that represent a reliability of the inference information, the inference information including inferences between the plurality of data mining rules and the previous slice instance datasets.

In one embodiment, the identifying of the first set of VNFs further includes, comparing the support parameters and the confidence parameters to the plurality of VNFs to identify the first set of VNFs from the plurality of VNFs, the first set of VNFs being VNFs that have high support and high confidence.

In one embodiment, the identifying of the first set of VNFs further includes, adding a fixed set of VNFs to the first set of VNFs, the fixed set of VNFs being VNFs that a network operator previously assigns to a particular VNF service.

In one embodiment, the determining of the association information includes, adjusting the first set of support and confidence parameters to derive a second set of support and confidence parameters.

In one embodiment, the adjusting of the first set of support and confidence parameters includes deriving a second set of data mining rules using at least one of statistical rules from the first set of VNFs and network operator preferences.

In one embodiment, the selecting of the second set of VNFs includes, applying the second set of support and confidence parameters to the plurality of VNFs, selecting VNFs with low support to be in the second set of VNFs.

In one embodiment, the obtaining of the support and confidence parameters includes extracting meta data from previous data slices to derive the support and confidence parameters.

At least another example embodiment relates to a network node.

In one embodiment, the network node includes, a memory storing computer-readable instructions; and at least one first processor configured to execute the computer-readable instructions such that the at least one first processor is configured to, obtain a first set of support and confidence parameters, identify a first set of VNFs of a plurality of VNFs of the communication network based on the first set of support and confidence parameters, determine association information by mining rules within VNFs of the first set of VNFs using the support and confidence parameters, select a second set of VNFs of the plurality of VNFs based on the association information, and control an operation of the communication network using the first set of VNFs and the second set of VNFs.

In one embodiment, the at least one first processor is configured to select the second set of VNFs without choosing any VNFs, of the plurality of VNFs, that belong to the first set of VNFs.

In one embodiment, the at least one first processor is configured to identify the first set of VNFs by, filtering a plurality of data mining rules for the communication network, using the first set of support and confidence parameters, to derive a first set of data mining rules, data mining the plurality of VNFs to identify the first set of VNFs using the first set of data mining rules.

In one embodiment, the at least one first processor is configured to obtain the first set of support and confidence parameters by, obtaining support parameters that represent a frequency of inference information within previous slice instance datasets, and obtaining confidence parameters that represent a reliability of the inference information, the inference information including inferences between the plurality of data mining rules and the previous slice instance datasets.

In one embodiment, the at least one first processor is configured to identify the first set of VNFs by, comparing the support parameters and the confidence parameters to the plurality of VNFs to identify the first set of VNFs from the plurality of VNFs, the first set of VNFs being VNFs that have high support and high confidence.

In one embodiment, the at least one first processor is configured to identify he first set of VNFs by, adding a fixed set of VNFs to the first set of VNFs, the fixed set of VNFs being VNFs that a network operator previously assigns to a particular VNF service.

In one embodiment, the at least one first processor is configured to determine the association information by, adjusting the first set of support and confidence parameters to derive a second set of support and confidence parameters.

In one embodiment, the at least one first processor is configured to adjust the first set of support and confidence parameters by, deriving a second set of data mining rules using at least one of statistical rules from the first set of VNFs and network operator preferences.

In one embodiment, the at least one first processor is configured to select the second set of VNFs by, applying the second set of support and confidence parameters to the plurality of VNFs, selecting VNFs with low support to be in the second set of VNFs.

In one embodiment, the at least one first processor is configured to obtain the support and confidence parameters by, extracting meta data from previous data slices to derive the support and confidence parameters.

### BRIEF DESCRIPTION OF THE DRAWINGS

FIG. 1 illustrates a virtual network function (VNF) in the form of a 3^{rd} generation partnership project (3GPP) evolved Node B (eNB) monolithic base station, in accordance with an example embodiment;

FIG. 2 illustrates a VNF in the form of a 5G access node, in accordance with an example embodiment;

FIG. 3 illustrates a system of VNFs included in network slices, in accordance with an example embodiment;

FIG. 4 illustrates a VNF selection system, in accordance with an example embodiment; and

FIG. 5 illustrates an example of a VNF selection method, in accordance with an example embodiment.

### DETAILED DESCRIPTION

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium, such as a non-transitory storage medium. A processor(s) may perform the necessary tasks.

Specific structural and functional details disclosed herein are merely representative for purposes of describing example embodiments. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be any non-transitory storage medium such as magnetic, optical, or flash memory, etc. Similarly, the transmission medium may be twisted wire pairs, coaxial cable, optical fiber, or some other suitable transmission medium known to the art. The example embodiments not limited by these aspects of any given implementation.

General Methodology:

Telecommunication networks, such as 5G networks, handle diverse service requirements while also using shared radio access network and computing physical resources. Nuanced abstractions may handle this balance appropriately. In particular, two primary abstractions may allow the network to handle a diverse set of services, which are: network slices, and virtual network functions (VNFs), as explained below in more detail.

A ‘network slice’ is a depiction of network resources during a period of time. In particular, a definition of a network slice is ‘a set of network functions, and resources to run these network functions, forming a complete instantiated logical network to meet certain network characteristics required by the Service instance(s),’ as described in “Description of Network Slicing Concept,” NGMN 5G P1 Requirements & Architecture, Jan. 13, 2016, the entire contents of which is hereby incorporated by reference in its entirety. Slices are therefore composed of modular network functions working that have been engaged to work in unison to provide network resources.

Virtual Network Functions (VNFs):

A VNF can have varying degrees of granularity. In an embodiment, the VNF may be modular and offer easy plug-and-play deployment and operation. VNFs can, for instance, be implemented as Virtual Machines or Application (“docker”) containers.

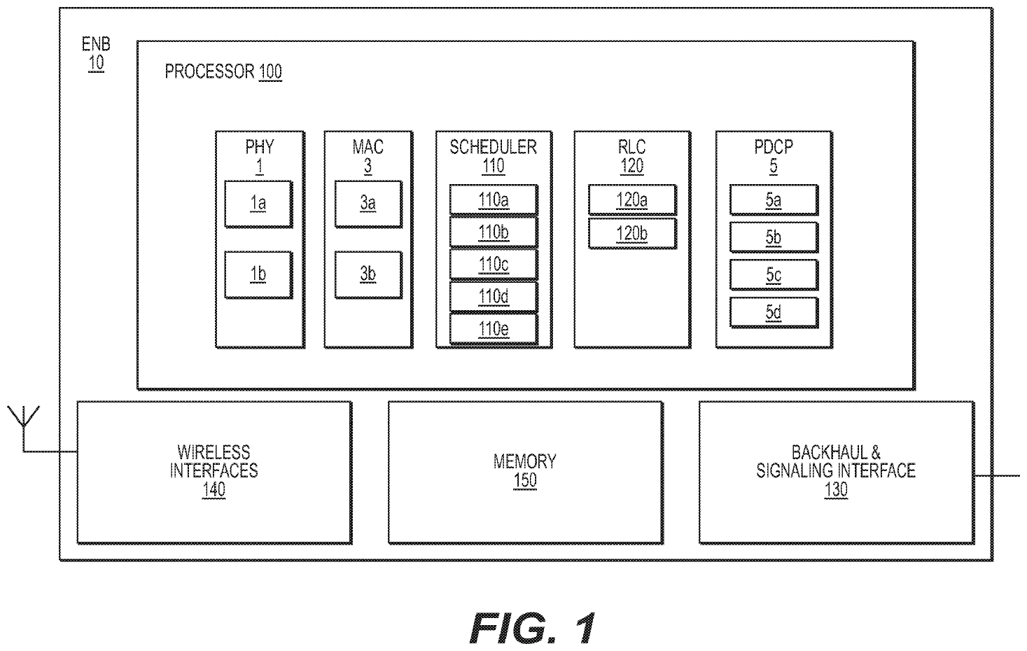

FIG. 1 illustrates a virtual network function (VNF) in the form of a 3^{rd} generation partnership project (3GPP) evolved Node B (eNB) monolithic base station 10, in accordance with an example embodiment. The VNF (eNB) 10 may include wireless interfaces 140, a backhaul interface 130, a memory storage 150 and a processor 100. The processor may include a scheduler 110 for scheduling transmissions to and from the eNB 10, where the scheduler may include scheduling modes (110a, 110b, 110e and 110d), or VNF “configuration modes,” for bearers of the eNB 10. The processor 100 may also include a radio link control (RLC) buffer 120, where the RLC may include RLC configuration modes (120a and 120b) for each bearer. The processor 100 may further include a physical layer 1 (with physical configuration modes 1a and 1b), a media access control (MAC) layer 3 (with MAC configuration modes 3a and 3b), and a packet data convergence protocol layer 5 (with configuration modes 5a, 5b, 5e and 5d). In this document, a “bearer” is considered to be a virtual link, a channel, or a data flow used to exchange information with other nodes within a communication network. It should be understood that the number of configuration modes for the physical layer 1, the MAC layer 3, the scheduler 110, the RLC 120 and the PDCP layer 5, may vary widely, where each example “mode” may relate to supporting a particular overall VNF configuration for the eNB 10. It should further be understood that the different “configuration modes” of the physical layer 1, the MAC layer 3, the scheduler 110, the RLC 120 and the PDCP layer 5, may be separate VNFs provided by separate VNF vendors/suppliers, or the different modes may all may be coupled into a single eNB 10.

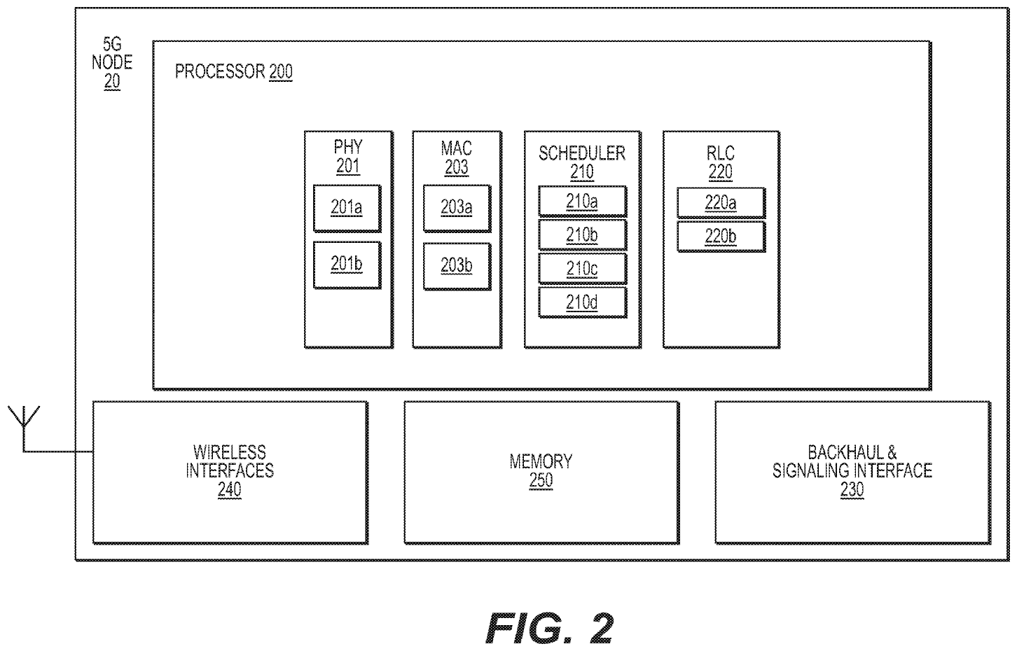

FIG. 2 illustrates another VNF in the form of a 5G access node 20, in accordance with an example embodiment. The VNF (5G node) 20 may include wireless interfaces 240, a backhaul interface 230, a memory storage 250 and a processor 200. The processor may include a scheduler 210 for scheduling transmissions to and from the eNB 20, where the scheduler may include scheduling layers (210a, 210b, 210c and 210d) for bearers of the eNB 20. The processor 200 may also include a radio link control (RLC) buffer 220, where the RLC may include layers (220a and 220b) for each bearer. The eNB may include a physical layer 201, with layers (201a and 201b) for the bearers, a media access control (MAC) layer 203, with layers (203a and 203b) for the bearers.

It should be understood that each individual VNF may possess attributes (characteristics) that potential number in the hundreds. Each ‘attribute’ of a VNF may add to the description and capabilities of the particular VNF. An ‘attribute’ may be provided by a VNF that is formed through the collection of potential “configuration modes” described in relation to the modes of the elements discussed in FIGS. 1 and 2, above. Example ‘attributes’ may correspond to selectable quality of service (QoS) attributes, for instance, that provide different QoS levels of service. For example, attributes may be considered specific configurable parameters, where QoS attributes (such as packet delay budget, packet loss, maximal bitrate, as an example) may be selectable, along with operating frequency (for instance 700 MHz, 2100 MHz, etc., depending on a service provider), system bandwidth (10 MHz for max 30 Mbps, 20 Mhz for max 60 Mbps, etc.), MIMO capabilities, X2 interface configuration, a selectable size of a RLC buffer, a selectable size of a PDCP buffer, etc.

When a ‘slice’ instance is created, a set of VNFs is selected where attributes of each of the selected VNFs are configured to meet an aggregate service requirement for the slice. Each VNF may also have multiple configuration modes (for instance, a low-latency mode, a high-volume mode, a very high number of active connections mode, etc.). Each pairing (tuple), which may include an identified VNF and a configuration mode for the VNF, may jointly be considered to be a ‘selected and/or selectable VNF’ for purposes of this document. The act of configuring a selected/selectable VNF to provide a specific service for a slice instance is called the ‘Preparation Phase’ of a slice lifecycle.

Slice Instance:

When a slice instance is created as a ‘slice blueprint,’ a set of VNFs may be gathered, and the attributes of each of the VNFs of the set may be configured to reflect aggregate service characteristics of that slice instance. Selecting the VNFs and configuring them is generally a manual process which is sometimes augmented by policies and/or deterministic rules. But, as the number of VNFs to choose from increases, and as the number of configuration parameters associated with each VNF becomes greater and more complex (with some of these configuration parameters being mutually exclusive, and other parameters sharing responsibilities with the configuration parameters of other VNFs), a manual selection of an optimum set of VNFs can become cumbersome and/or impractical.

For illustrative purposes, a number of VNFs in a slice may be assumed to be between seven and ten, though it should be understood that this number can go up and down significantly in real-life networking applications. Within this range of VNFs, a complexity of VNF selections can increase dramatically. For instance, if seven VNFs are to be utilized for a slice, and assuming that each VNF has five attributes of interest to configure, there will be 78,125 (5 ⁷) possible VNF selections to investigate. Meanwhile, if the number of VNFs increases to ten VNFs, where each VNF has five attributes of interest, the number of possible VNF selections increases to 9,765,625 (5¹⁰) possible selections. This simplified example assumes one degree of freedom for the five attributes, where four of the attributes are fixed (i.e., have default values) and only one varies. It should be understood that the search space to investigate can dramatically increase even further (beyond the number of VNF selections in these simple examples), if a greater degree of freedom and/or more attributes and/or VNFs are included in a slice. For instance, for VNFs with five attributes, where three are fixed (i.e., have default values), and the other two attributes may be chosen, then in this scenario each VNF has ten possible configuration combinations (5c2). Assuming there are seven VNFs, there will be 10,000,000(10⁷) possible VNF selections to examine. And, assuming there are 10 VNFs, there will be 10,000,000,000 (10¹⁰) possible VNF selections to examine.

Deterministic rules are unable to fully capture and exploit interesting pattern relationship between VNFs. Consider for instance that a slice instance uses a combination of two VNFs only in rare cases. To wit, once a slice instance is instantiated and put into service, the dynamic nature of the network requires that two VNFs then work in tandem to service traffic for that slice. Such a collusion of VNFs working together is not readily apparent just by examining the attribute selections.

In general, there are two disadvantages to relying on deterministic rules/policies to manually select VNFs: (1) a brute force search across a large search space hinders a choice of an optimal set of VNFs, especially considering that the number of VNFs to be examined will grow as 5G networks mature, as the number of attributes per VNF will also increase, and (2) deterministic rules and policies do not account for interesting relationship patterns that may be mined among the VNFs as they are put into service together.

Machine learning and/or data mining can optimize VNF selection during a preparation phase of a network slice instance. The machine learning and/or data mining can alleviate the disadvantages associated with relying on deterministic rules/policies to manually select VNFs. By mining the slice instance dataset, the VNF configuration information may be included with the decision to select a particular VNF. This is important, in order to no longer be dependent on an expansive search across a large selection space in order to find an optimally configured set of VNFs.

The instant example embodiments, and the disclosed method described below, provide advantages in VNF selection by automatically engaging a set of VNFs that provide network resources for a network slice instance without knowledge of real-time conditions, such as state information for the network, cloud resource information, and/or user equipment device capabilities. Instead, the automatic VNF selection may be determined based on a service definition information (e.g., ultra low-latency service, high-bandwidth service, etc.), and a dataset of previous constructed slices, slice instances, and their corresponding VNFs. This automatic VNF selection can be accomplished without human intervention (i.e., the selection occurs without the need for manual human input, or other human input, in order to instantiate a slice instance).

It should therefore be understood that, for VNF selection, the following is an example list of information that is not required to make the selection: current (and instantaneous) network conditions, such as congestion or available bandwidth; other ‘instantaneous information’ related to the network; current subscriber behavior with respect to type of applications being used and how active the subscriber is; type of service information that is needed (such as a data rate of the slice being constructed), latency and/or availability requirements (SLAs).

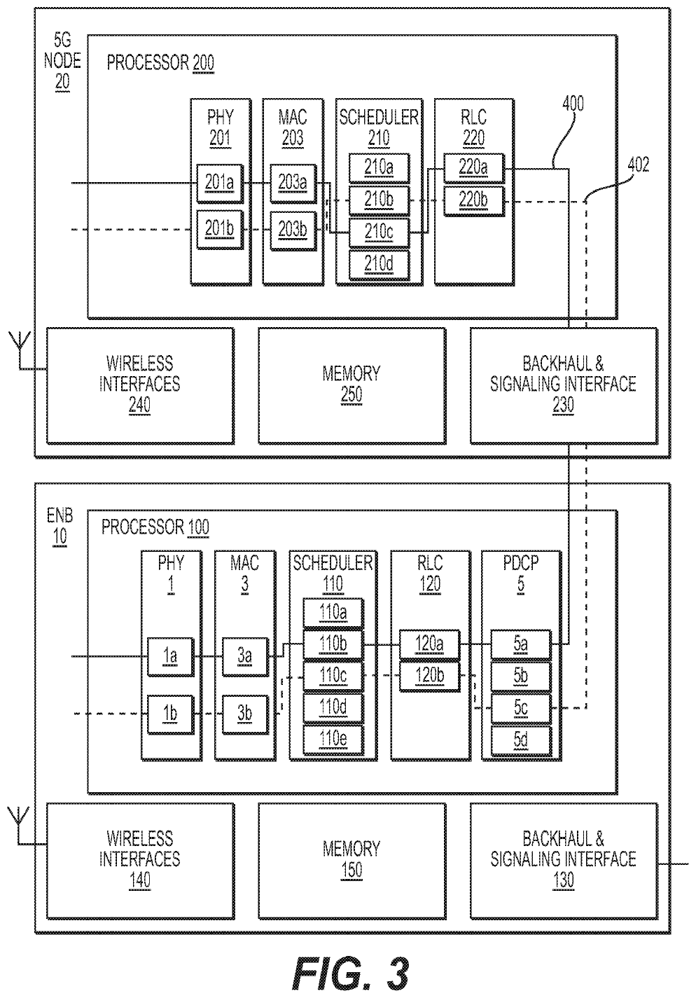

FIG. 3 illustrates a simplified system of two VNFs engaged in network slices, in accordance with an example embodiment. It should be understood that this slice is a simplified example, from the standpoint that only two physical structures (eNB 10 of FIG. 1, and 5G node 20 of FIG. 2) are included in two slices 400/402, it should be understood that a slice may include additional nodes (such as a LTE core node, a Wifi node, an application on a user equipment, etc.), and each of the nodes may include less or more “configuration modes” (as shown in FIG. 3, and as described in relation to FIGS. 1-2, above).

### Specific Example Embodiments

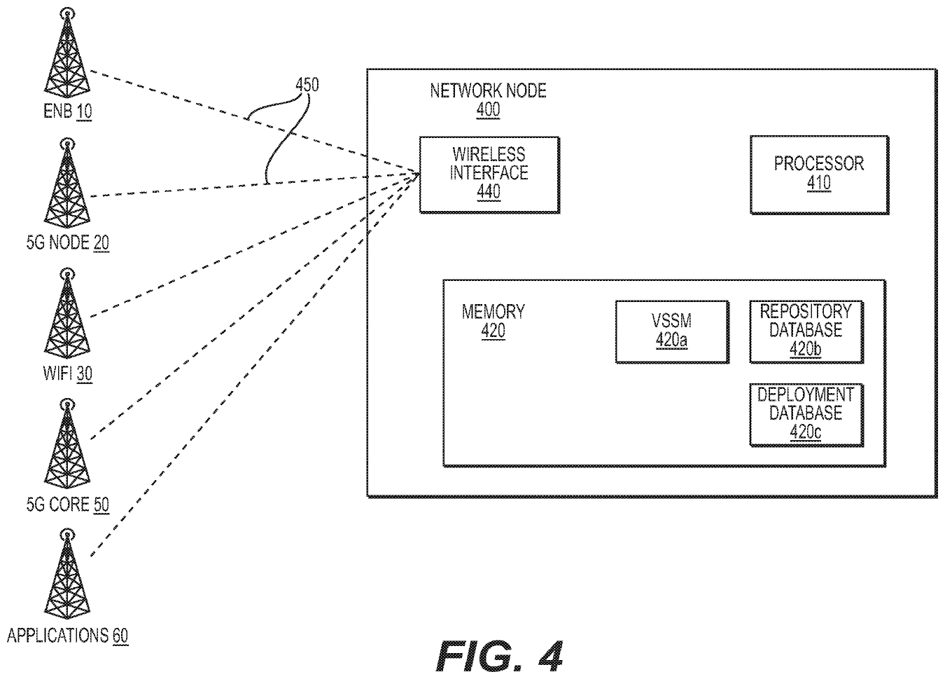

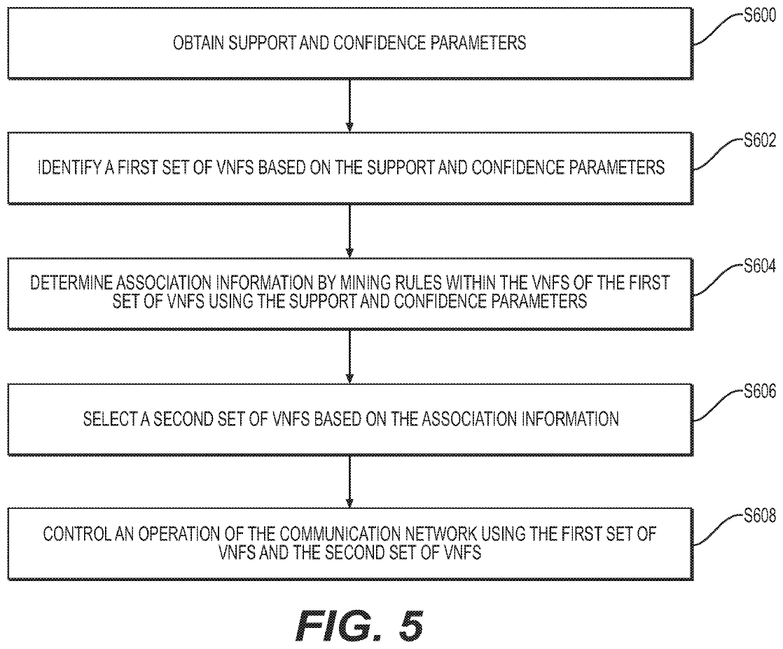

FIG. 4 illustrates a VNF selection system, in accordance with an example embodiment. The system includes a network node 400 that includes a wireless interface 440, a memory storage 420 and a processor 410. The memory may include: a VNF selection system module (VSSM) 420a, a VNF repository database 420b and a VNF deployment history database 420c. The purposes of the VSSM 420a and the databases 420b and 420c is described below in conjunction with FIG. 5.

The network node 400 may use signaling 450 between VNFs of the communication network. The VNFs may include, as an example, the eNB 10 (FIG. 1), the 5G node 20 (FIG. 2), as well as other nodes such as a wifi node 30, an LTE node 40, a 5G core node 50, and/or user equipment applications 60 on a user equipment. It should be understood that the nodes 30. 40, 50 and 60 each have a structure that includes a processor, a tangible computer-readable memory, a wireless interface and/or a backhaul connection, that is common to the structure depicted in FIGS. 1-2, described above.

FIG. 5 illustrates an example of a VNF selection method, in accordance with an example embodiment. The steps of this method may be saved in the memory 420 as a set of instructions, where the instructions may be included in a VNF selection system module (VSSM 420a). The processor 410 of the network node 400 interfaces with the VSSM 420a to access the instructions so that the processor 410 performs the method steps described herein in relation to FIG. 5. The repository database 420b may contain the VNFs that the network operator may select from, while the deployment database 420c may contain slice statistics from previous instances (previous “datasets”) of network slices that the operator has previously deployed, where the “previously deployed” slices have since terminated. When a network slice terminates, or even during an execution of a slice, the processor 410 may cause statistics from the slice instance to be saved in database 420c, and these statistics can later be mined. These statistics may include the set of VNFs that participated in the slice instance, the slice instance runtime duration, the total bandwidth used by the slice, the total bytes observed in the slice, the contribution of each VNF to the slice instance (in terms of how long the VNF was active and how many subscribers the VNF served, etc., as an example), or other statistics that may be used to identify the success of the slice instance. It should be understood that these representative statistics are examples of statistics that can be collected, though similar additional statistics may also be collected to aid in the future selection of VNFs for a new (next) slice instance.

As shown in FIG. 5, in step S600, the instructions of the VSSM 420a cause the processor 410 to obtain ‘support and confidence parameters.’ In an embodiment, the ‘support and confidence’ parameters may be used to gather a number of rules (referred to in this document as “data mining rules”) from the database 420c, and therefore, the parameters may also be used to determine the VNFs that may be appropriately chosen for a slice instance. Support and confidence are objective measures in the association analysis theory. In pertinent theory, X→Y can be a rule, where X and Y are sets of VNFs. The implications state that whenever the set of VNFs in X occurs (the antecedent), then the VNF in set Y is also observed (the consequent). Therefore, “support” finds the rules (i.e., inferences) that occur most frequently in the dataset, and “confidence” measures the reliability of the inference (i.e., “inference information”) made by the same rule/inference.

In step S602, the processor 410 identifies a first set of VNFs, based on the support and confidence parameters. This first set of VNFs is determined by the processor 410 machine learning and/or data mining previous slice instances involving past VNFs that participated in similar network services, e.g., a low-latency service or a high bandwidth service. This first set of VNFs is mined from the deployment dataset 420c, and may be augmented with network operator preferences, as described below. It should be understood that each pairing of a VNF with a configuration mode may be considered a tuple, where each individual tuple (the identity of the VNF, and an associated configuration mode for the VNF) may then be considered a unique VNF. Therefore, the structure associated with a VNF (such as the structure shown in FIGS. 1-2) may effectively represent a number of VNFs. In an embodiment, the set of VNFs chosen in step S602 may include fixed VNFs that the network operator may wish to include for a slice instance for a particular VNF service. Such fixed VNFs may result from network operator policies or preferences for utilizing certain VNFs for a slice instance. As an example, the network operator may want to always include a 5G scheduler VNF in a slice instance. In an embodiment, step S602 may harvest (mine) from the deployment database 420c the rules that exhibit “high support” and “high confidence.”

In step S604, the processor 410 identifies “association information” between VNFs of the first set of VNFs. The process of mining the rules, extracting meta data from VNFs, and obtaining network operator preferences (i.e., network operator rules), each may relate to determining ‘association information.’ The association information analysis can be accomplished, in part, via the methods described in ‘Introduction to Data Mining,’ Pang-Ning Tan, Michael Steinbach and Vipin Kumar, 1e, Pearson Publishing, 2005, the entire contents of which is incorporated herein by reference in its entirety. In this step, the processor 410 may further vary values for the ‘support and confidence’ parameters obtained in step S600, in order to further mine the rules, and from these rules the processor 410 may extract relevant VNFs. In an alternative embodiment, the processor 410 may use the support and confidence parameters obtained in Step S600 to create another metric known in the association analysis theory as lift, in order to further mine the rules, and from these rules the processor 401 may extract relevant VNFs. In an embodiment, the processor 410 may also take into account the network operator preferences for certain VNFs within the VNF selection process. The association analysis can be used to mine meta data from the first set of VNFs, and to add to use the meta data to identify a second set of possible VNFs that may then be combined with the first set of VNFs (in step S606). To mine the dataset through two data mining phases to converge on set of VNFs pertinent to the slice being constructed.

For a service S, there will be a set of VNFs that is always utilized, and a (perhaps) smaller set of VNFs whose membership may show some randomness with respect to the choice of the VNFs in the set. This can be depicted, as shown below.

VNFₛ=VNF_{fixed}U VNF_{varied} Equation 1

Within the smaller set (VNF_{varied}) there may be further variability as exhibited by VNF coupling (or preference for VNFₓ to appear with VNF_{y}). The instant method captures these nuances and dependencies as well.

This method consists of two distinct phases. In the first phase, the processor 410 finds VNF_{fixed}. VNF_{fixed} results from the first act of mining database 420c (step S602), and may be augmented with network operator preferences for including (or excluding) certain VNFs.

In an embodiment, the processor 410 harvests all of the first set of VNFs (in Phase I) that exhibit ‘high support’ and ‘high confidence’ as part of Step S602 and Step S604. Phase I uses high values for support and confidence to get a set of rules. It then examines the top n rules (where n is an integer), and creates a union of all VNFs in those rules.

In step S606, the processor 410 selects a second set of VNF's from database 420c This constitutes Phase II (described above), where the processor 410 determines VNF_{varied}. Here, the processor 410 mines ‘low-support VNFs.’ These may represent distinct cases where ‘low-support VNFs’ represent infrequent network conditions that are important enough to capture. Furthermore, in these low-support VNFs there may be a pairing of VNFs that indicates the mutual dependency of VNFs to fully realize the service under certain network condition. It should be understood that the second set of VNF's do not include any of the VNF's from the first set of VNF's.

In Phase II, the processor 410 iteratively examines the dataset, increasing the support in each iteration. In each iteration, the algorithm seeks out low-support, but high confidence rules, and mines the top n rules (n=2, since we want to constrain the desire to pick up too many low-support VNFs). Once such rules are determined, the processor 410 adds them to the subset of VNFs that may be potentially utilized for the slice instance. The method terminates when the only rules it can mine contain VNFs that have already been identified to be within the first VNF subset.

In step S608, the processor 410 uses the first set of VNFs and the second set of VNFs to control an operation of the network. That is to say, the processor 410 uses signaling 450 to communicate with the VNFs (such as eNB 10, 5G access node 20, wifi node 30, LTE node 40, 5G core node 40 and/or user equipment applications 60), in order to recruit the selected VNFs (i.e., the VNFs in the first VNF subset), by notifying each selected VNF, within the first or second set of VNFs, that it is to be involved in providing resources for the network slice.

The above-described data mining and machine learning process can benefit from one or more datasets of previously constructed slices and their corresponding VNFs (Deployment Database 420c). In a 5G network architecture, such datasets may not already exist. Therefore, service providers may, in the early stages of the use of the example embodiment method (described above), use static policies and rules to choose VNFs. These static policies and rules can be reflected and will operate on a minimal or “empty” dataset (i.e., a dataset that does not include any previous data). To allow for operator rules and policies, the example embodiments allow for front-loading the VNFs. Front-loading of the VNFs can be performed by initializing the method with a set of N datasets (i.e., the method therefore will not begin with a null set). That is to say, the method may start with a set of VNFs that the service provider wishes to use for a particular service. In an alternative embodiment, if the initial dataset is empty, then Phase I and Phase II of the method will not result in any additional VNFs being added to N, thereby preserving the original VNFs set front-loaded by the service provider.

As an alternative to such front-loading, synthetic slice instance datasets can be generated either from simulating network traffic in a simulation environment, or by writing tools that can generate synthetic datasets. Network data collected in laboratory settings, sandboxes, and similar environments can further inform the synthetic generation of a slice instance dataset.

Beyond synthetic data, the method can collect data continuously from an actual network slice instance. As slice instances are created, used and subsequently destroyed, they can be monitored to extract meta data. In an example embodiment, a measure of slice instance preparation success can be introduced via a score that may be assigned in the last phase of slice lifecycle (i.e., the slice termination phase). The success score may be computed using Quality of Experience (QoE) feedback from user equipments (UEs) that are served by the slice. In another example embodiment, a success score may be computed using normalized service time of the slice (e.g., percentage of the overall required service time that the slice is activated with a prepared VNF set that performed satisfactorily, without a need to change the prepared VNF set, where a higher percentage may correspond to higher success score).

In an example embodiment, the slice instance meta data may include, among other attributes, information identifying whether the slice instance terminated normally or abnormally, which of the VNFs were actually activated during the slice instance execution, and how long the slice instance was active. It should be understood that this is not an exhaustive list of examples, but a representative list of meta data elements that may be captured as a slice instance goes through its lifecycle. This information may be saved in a database of previously constructed slice instances along with the slice's corresponding VNFs. This dataset will therefore grow over time and allow the data mining/machine learning method to discover interesting patterns in VNF selection that are not obvious and are beyond the capability of being represented by static rules.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the example embodiments. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof

The functions of the various elements shown in the example embodiments, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional or custom, may also be included.

Example embodiments may be utilized in conjunction with various telecommunication networks and systems, such as the following (where this is only an example list): Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TIA IS-95; a High Rate Packet Data (HRPD) system, Worldwide Interoperability for Microwave Access (WiMAX); Ultra Mobile Broadband (UMB); 3^{rd} Generation Partnership Project LTE (3GPP LTE); and 5G networks.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

1. A method of selecting virtual network functions (VNFs) to control an operation of a communication network, comprising:
obtaining, by at least one first processor, a first set of support and confidence parameters;
identifying, by the at least one first processor, a first set of VNFs of a plurality of VNFs of the communication network based on the first set of support and confidence parameters;
determining, by the at least one first processor, association information by mining rules within VNFs of the first set of VNFs using the support and confidence parameters;
selecting, by the at least one first processor, a second set of VNFs of the plurality of VNFs based on the association information; and
controlling, by the at least one first processor, an operation of the communication network using the first set of VNFs and the second set of VNFs.

2. The method of claim 1, wherein the selecting of the second set of VNFs accomplishes this selection without choosing any VNFs, of the plurality of VNFs, that belong to the first set of VNFs.

3. The method of claim 1, wherein the identifying of the first set of VNFs includes,
filtering a plurality of data mining rules for the communication network, using the first set of support and confidence parameters, to derive a first set of data mining rules,
data mining the plurality of VNFs to identify the first set of VNFs using the first set of data mining rules.

4. The method of claim 3, wherein the obtaining of the first set of support and confidence parameters includes,
obtaining support parameters that represent a frequency of inference information within previous slice instance datasets, and
obtaining confidence parameters that represent a reliability of the inference information, the inference information including inferences between the plurality of data mining rules and the previous slice instance datasets.

5. The method of claim 4, wherein the identifying of the first set of VNFs further includes,
comparing the support parameters and the confidence parameters to the plurality of VNFs to identify the first set of VNFs from the plurality of VNFs, the first set of VNFs being VNFs that have high support and high confidence.

6. The method of claim 3, wherein the identifying of the first set of VNFs further includes,
adding a fixed set of VNFs to the first set of VNFs, the fixed set of VNFs being VNFs that a network operator previously assigns to a particular VNF service.

7. The method of claim 4, wherein the determining of the association information includes,
adjusting the first set of support and confidence parameters to derive a second set of support and confidence parameters.

8. The method of claim 7, wherein the adjusting of the first set of support and confidence parameters includes deriving a second set of data mining rules using at least one of statistical rules from the first set of VNFs and network operator preferences.

9. The method of claim 7, wherein the selecting of the second set of VNFs includes,
applying the second set of support and confidence parameters to the plurality of VNFs,
selecting VNFs with low support to be in the second set of VNFs.

10. The method of claim 1, wherein the obtaining of the support and confidence parameters includes extracting meta data from previous data slices to derive the support and confidence parameters.

11. A network node, comprising:
a memory storing computer-readable instructions; and
at least one first processor configured to execute the computer-readable instructions such that the at least one first processor is configured to,
obtain a first set of support and confidence parameters,
identify a first set of VNFs of a plurality of VNFs of the communication network based on the first set of support and confidence parameters,
determine association information by mining rules within VNFs of the first set of VNFs using the support and confidence parameters,
select a second set of VNFs of the plurality of VNFs based on the association information, and
control an operation of the communication network using the first set of VNFs and the second set of VNFs.

12. The network node of claim 11, wherein the at least one first processor is configured to select the second set of VNFs without choosing any VNFs, of the plurality of VNFs, that belong to the first set of VNFs.

13. The network node of claim 11, wherein the at least one first processor is configured to identify the first set of VNFs by,
filtering a plurality of data mining rules for the communication network, using the first set of support and confidence parameters, to derive a first set of data mining rules,
data mining the plurality of VNFs to identify the first set of VNFs using the first set of data mining rules.

14. The network node of claim 13, wherein the at least one first processor is configured to obtain the first set of support and confidence parameters by,
obtaining support parameters that represent a frequency of inference information within previous slice instance datasets, and
obtaining confidence parameters that represent a reliability of the inference information, the inference information including inferences between the plurality of data mining rules and the previous slice instance datasets.

15. The network node of claim 14, wherein the at least one first processor is configured to identify the first set of VNFs by,
comparing the support parameters and the confidence parameters to the plurality of VNFs to identify the first set of VNFs from the plurality of VNFs, the first set of VNFs being VNFs that have high support and high confidence.

16. The network node of claim 13, wherein the at least one first processor is configured to identify the first set of VNFs by,
adding a fixed set of VNFs to the first set of VNFs, the fixed set of VNFs being VNFs that a network operator previously assigns to a particular VNF service.

17. The network node of claim 14, wherein the at least one first processor is configured to determine the association information by,
adjusting the first set of support and confidence parameters to derive a second set of support and confidence parameters.

18. The network node of claim 17, wherein the at least one first processor is configured to adjust the first set of support and confidence parameters by,
deriving a second set of data mining rules using at least one of statistical rules from the first set of VNFs and network operator preferences.

19. The network node of claim 17, wherein the at least one first processor is configured to select the second set of VNFs by,
applying the second set of support and confidence parameters to the plurality of VNFs,
selecting VNFs with low support to be in the second set of VNFs.

20. The network node of claim 11, wherein the at least one first processor is configured to obtain the support and confidence parameters by,
extracting meta data from previous data slices to derive the support and confidence parameters.
